(19) United States
(12) Patent Application Publication
(10) Pub. No.: US 2021/0142247 A1
(43) Pub. Date: May 13, 2021

(54) SYSTEMS AND METHODS FOR SCHEDULING CONTRACTOR AGENTS BASED ON RESIDUALS

(71) Applicant: Talkdesk, Inc., San Francisco, CA (US)

(72) Inventors: Jason Fama, San Carlos, CA (US); Richard Lawrence, San Diego, CA (US); Spencer Wiedman, Sunnyvale, CA (US); Tiago Paiva, San Francisco, CA (US)

(21) Appl. No.: 16/684,767

(22) Filed: Nov. 15, 2019

Related U.S. Application Data
(63) Continuation of application No. 16/680,713, filed on Nov. 12, 2019.

(51) Int. Cl. G06Q 10/06; H04M 3/523

(52) U.S. Cl. CPC G06Q 10/06315; G06Q 10/063116; H04M 3/5233; G06Q 10/06393

(57) ABSTRACT

A system for predicting freelancer needs for an entity such as a contact center is provided. The system determines a residual for a queue at an interval based on the number of agents scheduled to wok during the interval, a forecast associated with the queue for the interval, and a service level goal for the interval. A residual is defined as the number of agents needed for the queue for the interval in order to meet the service goal for the interval. After determining the residual, the system can request one or more agents to work on the queue during the interval. As agents are scheduled for the queue for the interval, the residual may be recalculated to determine if additional contractor agents may be requested.

### CROSS-REFERENCE TO RELATED APPLICATIONS

This application is a continuation of U.S. patent application Ser. No. 16/680,713 filed on Nov. 12, 2019, entitled “SYSTEMS AND METHODS FOR SCHEDULING CONTRACTOR AGENTS BASED ON RESIDUALS.” The contents of which are hereby incorporated by reference.

### BACKGROUND

Contact centers use freelance or outsourced agents (collectively referred to herein as contactor agents) for a variety of reasons. These reasons include cost (using a contractor agent may be cheaper than onboarding a full or part time agent), variability in contact center demand (day to day variation in communication volume may make it difficult to keep fully employed agents busy every day), rapid growth (the contact center may grow faster than new agents can be hired), speed in onboarding (contractor agents can be put to work faster than newly hired agents), and regional or off-hours support (contractor agents in other countries can be used to answer communications that are received off-hours).

However, predicting on an ongoing basis how many contractor agents the contact center needs is a challenging problem that is not well solved by systems today.

### SUMMARY

A system for predicting contractor agent needs for an entity such as a contact center is provided. The system determines a residual for a queue at an interval based on the number of agents scheduled to work during the interval, a forecast associated with the queue for the interval, and a service level goal for the interval. A residual is defined as the number of additional agents needed for the queue for the interval in order to meet the service level goal for the interval. After determining the residual, the system can request one or more contractor agents to work on the queue during the interval. As contractor agents are scheduled for the queue for the interval, the residual may be recalculated to determine if additional contractor agents may be requested.

In an embodiment, a method is provided. The method includes: receiving an indicator of a queue and an interval of a plurality of intervals, wherein the queue is associated with a service level for the interval: determining a number of agents scheduled to work on the queue for the interval; determining a number of agents needed to meet a service level goal for the interval; and calculating a residual for the interval based on a difference between the determined number of agents scheduled and the determined number of agents needed.

In an embodiment, a method is provided. The method includes: receiving indicators of a plurality of queues; for each queue of the plurality of queues: for each interval of a plurality of intervals: determining a number of agents scheduled to work on the queue for the interval; determining a number of agents needed to meet a service level goal for the interval; calculating a residual for the interval based on a difference between the determined number of agents scheduled and the determined number of agents needed; and requesting additional agents for the queue based on the residual.

In an embodiment, a method is provided. The method includes: receiving indicators of a plurality of queues, wherein each queue is associated with a weekly goal; receiving a schedule for the plurality of queues and a forecast for the plurality of queues; simulating the plurality of queues based on the received schedule and the forecast; determining queues of the plurality of queues that are understaffed based on the simulation and the weekly goals for each queue; and based on the plurality of queues that are understaffed, determining a residual for each queue of the plurality of queues that are understaffed.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is an illustration of an example system architecture;

FIG. 2 is an illustration of an example environment for the assignment and management of contractor agents;

FIG. 3 is an illustration of an example method for calculating a residual for a queue and for requesting agents based on the residual;

FIG. 4 is an illustration of an example method for requesting agents for a plurality of queues based on residuals calculated for each queue;

FIG. 5 is an illustration of an example method for determining residuals for a plurality of queues;

FIG. 6 is an illustration of an example method for determining residuals for a plurality of queues; and

FIG. 7 illustrates an example computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described within a cloud-based contact center, it will become evident to those skilled in the art that the implementations are not limited thereto.

FIG. 1 is an example system architecture 100, and illustrates example components, functional capabilities and optional modules that may be included in a cloud-based contact center infrastructure solution. Customers 110 interact with a contact center 150 using voice, email, text, and web interfaces in order to communicate with the agents 120 through a network 130 and one or more of text or multimedia channels. The system that controls the operation of the contact center 150 including the routing and handling of communications between customers 110 and agents 120 for the contact center 150 is referred to herein as the contact routing system 153. Depending on the embodiment, the contact routing system 153 could be any of a contact center as a service (CCaS) system, an automated call distributor (ACD) system, or a case system, for example.

The agents 120 may be remote from the contact center 150 and may handle communications with customers 110 on behalf of an enterprise. The agents 120 may utilize devices, such as but not limited to, work stations, desktop computers, laptops, telephones, a mobile smartphone and/or a tablet. Similarly, customers 110 may communicate using a plurality of devices, including but not limited to, a telephone, a mobile smartphone, a tablet, a laptop, a desktop computer, or other. For example, telephone communication may traverse networks such as a public switched telephone networks (PSTN), Voice over Internet Protocol (VoIP) telephony (via the Internet), a Wide Area Network (WAN) or a Large Area Network. The network types are provided by way of example and are not intended to limit types of networks used for communications.

In some embodiments, the agents 120 may be assigned to one or more queues. The agents 120 assigned to a queue may handle communications that are placed in the queue by the contact center 150. For example, there may be queues associated with a language (e.g., English or Chinese), topic (e.g., technical support or billing), or a particular country of origin. When a communication is received by the contact center 150, the communication may be placed in a relevant queue, and one of the agents 120 associated with the relevant queue may handle the communication.

Generally, there may be two types of agent 120 associated with a contact center 150. The first type of agent 120 is an employee agent 120 and is typically a full or part time employee of the contact center 120. The second type of agent 120 is referred to herein as a contractor agent 120. Contractor agents 120 may not be employees of the contact center 150 and are typically contracted to work for the contact center 150 for short periods of time based on predicted needs. The contractor agents 120 may be paid by the contact center 150 or may be paid by an agency or other entity that provided contractor agents 120 to the contact center 150. Contractor agents 120 may include both freelance agents, outsource agents, and any other type of temporary agent.

As described above, the use of contractor agents 120 in a contact center 150 has many advantages including cost and speed of deployment. However, there are drawbacks associated with the use of contractor agents 120. First, it is often difficult to determine when and how many contractor agents 120 are needed. Second, once a decision to hire contractor agents 120 has been made, there is often significant overhead associated with the hiring and managing of the contractor agents 120.

Accordingly, to solve the drawbacks associated with contractor agents 120, the environment 170 further includes a contractor service 170. The contractor service 170 determines when a queue associated with an entity such as the contact center 150 will require one or more contractor agents 120 for an interval to meet a service level goal. As used herein an interval is a smallest amount of time (e.g., 15 minutes, 30 minutes, or 1 hour) that an agent 120 can be scheduled to work on a queue.

Once a need has been determined for a queue for an interval, the contractor service 170 can request one or more contractor agents 120 to work for the entity or contact center 150. Once hired, an alias may be assigned to the contractor agent 120 that allows the contractor service 170 to track the performance of the temporary agent 120. The contractor service 170 may further allow managers to associate the agents 120 with statuses such as preferred or not-preferred using the aliases. A preferred agent 120 may be given preferential access to available shifts for an entity or contact center 150. A non-preferred agent 120 may be prevented from taking shifts for the entity or contact center 150 or may be assigned less desirable shifts. The workings of the contractor service 170 will be described in further detail with respect to FIG. 2.

FIG. 2 is an illustration of an example environment 200 for the assignment and management of contractor agents 120. As shown, the environment 200 includes a contractor service 170 in communication with a contact center 150. The contractor service 170 includes a residual engine 205 and a contractor engine 225. Depending on the embodiment, each of the residual engine 205 and the contractor engine 225 may be implemented together or separately by one or more general purpose computing devices such as the computing system 700 illustrated with respect to FIG. 7.

The residual engine 205 may calculate a residual 207 for a queue 125 for an interval. As used herein, the residual 207 (or residual need) is the additional number of single skilled agents 120 that are needed to work on a queue 125 for an interval to meet or achieve a particular goal for the interval. The goal may be meeting a particular service level or performance metric for the interval. The goal for an interval and/or queue 125 may be set by a user or administrator, for example. Depending on the embodiment, the residual 207 may be the residual 207 for a particular queue 125 or for all queues 125 associated with an entity or contact center 150.

How the residual agent 120 calculates the residual 207 for an interval may depend on the time period or horizon associated with the interval. Depending on the embodiment, the horizons may include an intraday or intraweek horizon, what is called a scheduling horizon, and what is called a longer term scheduling horizon. Other horizons may be considered.

The intraday and intraweek horizon may include intervals that fall within a current day or a current week. The scheduling horizon may be entity or contact center specific and may include intervals falling around one to six weeks out. The number of weeks in the scheduling horizon may depend on how far out the entity or contact center 150 typically schedules agents 120 to queues 125. The longer term scheduling horizon may include any interval that is after the scheduling horizon.

For interweek/interday and the scheduling horizon, the residual engine 205 may calculate the residuals 207 using a combination of binary search and discrete event simulation during what is referred to herein as the “residual need” algorithm. Initially, the residual engine 205 may receive a current schedule 211 for each queue 125. The schedule 211 for a queue 125 may include each interval under consideration by the residual engine 205 along with the number of agents 120 associated with the queue 125. Note that each queue 125 may be associated with a skill that is needed by agents 120 to handle calls or communications from the queue 125.

The residual engine 205 may further receive a forecast 209 for each queue 125. The forecast 209 for a queue 125 may include a prediction or predictions of the number of communications that may be received by the queue 125 during each interval under consideration. The forecast 209 may be determined by the residual engine 205 using historical data about communications received by the queue 125 (or similar queues 125) for the interval. Any system and method for generating forecasts 209 may be used.

For each queue 125 and for each interval under consideration that is understaffed with agents 120, as determined based on the schedule 211 and the forecast 209 for the interval, the residual engine 205 may calculate the residual 207 for the queue 125 using the residual need algorithm. If the queue 125 is an immediate queue, the residual engine 205 may determine the number of single skilled agents 120 that are needed for the queue 125 using a binary search. At each stage of the search the residual engine 205 may run a simulation of the queue 125 based on the assigned agents 120 and the forecast 209 and may run the binary search on the simulation. The residual engine 205 may continue searching and simulating until the number of additional agents 120 needed to exceed the service level goal for the queue 125 is determined. The number of additional agents 120 is the residual 207.

For deferred queues 125 that are understaffed, the simulation of the queue 125 for the interval may not be necessary. Here, the residual engine 205 may determine the number of agents 120 scheduled to work on the queue 125 for the interval, and the number of agents 125 that are needed to work on the queue 125 to meet or exceed the service level goal for the queue 125. The difference between the two numbers is the residual 207 for the queue 125.

In some embodiments, the residual engine 205 may recalculate the residual 207 for a queue 125 for an interval each time agents 125 are added or removed from the schedule 211 for the interval. In addition, the residual engine 205 may recalculate the residuals 207 for one or more queues 125 for one or more intervals in response to detecting a surge period. In particular, the residual engine 205 may recalculate the residuals 207 for each interval that falls within a predicted surge period.

For intervals that are located after the scheduling horizon for the entity or contact center 150, the residual engine 205 may calculate the residuals 207 using a different method referred to herein as the “planning residual need” algorithm. Depending on the embodiment, the residual engine 205 may calculate residuals 207 for week sized intervals.

For the planning residual need algorithm, the residual engine 205 may calculate the residuals 207 for one or more queues 125 for a week by first simulating the queues 125 using the forecast 209 and most recent schedule 211 for the queues 125. The most recent schedule for the queue 125 may be a recent schedule that is not atypical due to holidays, marketing campaigns, or other unusual events. Based on the simulations, the residual engine 205 may determine which queues 125 are understaffed and unable to meet their weekly or service level goal.

Once the understaffed queues 125 (if any) are determined, the residual engine 205 may iterate over the determined queues 125 starting with the smallest queue 125 by communication volume. Considering the smallest queue 125, the residual engine 205 may perform a binary search for the percent increase in agents 120 to meet the weekly service level goal across all agents 120 that at least have the skill associated with the queue 125. The residual engine 205 may determine the percentage at each iteration for successively larger queues 125. Once all of the queues 125 have been considered, the residual engine 205 may output the residual 207 for the week for each queue 125 that includes the number of agents 120 needed and the associated skill.

The contractor engine 225 may receive residuals 207 for one or more intervals and for one or more queues 125 from the residual engine 205 and may attempt to identify contractor agents 120 that can satisfy the received residuals 207. A contractor agent 120 may satisfy a residual 207 if the contractor agent 120 is not scheduled to work on another queue 125 during the associated interval and the contractor agent 120 has the skills required by the queue 125 associated with the residual 207.

In some implementations, the contractor engine 225 may maintain a database or list of available contractor agents 120. The list may include an indicator of each contractor agent 120, the skills associated with the contractor agent 120, and indicators of the intervals that the contractor agent 120 is scheduled to work on a queue 125 associated with the contact center 150. Other types of data structures may be used. The contractor engine 225 may determine contractor agents 120 that satisfy a residual 207 using the list. As will be described further below, in some embodiments, each contractor agent 120 in the list may be associated with an alias.

The contractor engine 225 may contact each contractor agent 120 that satisfies the residual 207 and may request that the contractor agent 120 work during the interval associated with the residual 207. For example, the contractor engine 225 may send a link to the contractor agent 120 via email, SMS, or other electronic messaging means, that identifies the interval and the queue 125 and allows the contractor agent 120 to accept or reject the offer to work during the interval.

In some embodiments, which contractor agents 120 the contractor engine 225 may offer work to may depend on the horizon associated with the residual 207. For example, for the intraweek or intraday horizon, the contractor engine 225 may favor offering the work for a residual 207 to contractor agents 120 who are freelancers because these types of agents 120 are flexible and often have short term availability. Contractor agents 120 that are outsourcers typically work on longer-term placements, and therefore the contractor engine 225 may favor these agents 120 when placing work associated with farther out horizons.

If the contractor agent 120 accepts the offer to work during the interval, the contractor engine 225 may add the contractor agent 225 to a calendar or a schedule 211 associated with the queue 125 for the interval. Depending on the embodiment, the contractor engine 225 may add the alias associated with the contractor agent 120 to the calendar or schedule 211 such that the identity of the contractor agent 120 cannot be determined by an administrator viewing the calendar or schedule 211.

How the contractor engine 225 offers contractor agents 120 work opportunities may be dependent on the type of the particular contractor agent 120. For example, contractor agents 120 that are freelance agents 120 may be offered to work intervals from one schedule 211 at a time. Contractor agents 120 that are outsourcers may be offered to work in bulk opportunities that may include intervals across multiple schedules 211.

The contractor engine 225 may monitor and track the performance of the contractor agents 120 overtime using the aliases associated with each contractor agent 120. The performance of a contractor agent 120 may be based on various metrics such as call quality, average call time, etc. The performance may further be based on results of customer surveys. Any method for measuring the performance of agents 120 in a contact center 150 may be used.

The contractor engine 225 may provide a report through which an administrator can view the performance metrics collected about each contractor agent 120. The contractor engine 225 may provide the report in a graphical user interface, for example. The administrator may view the report and may take assign one or more statuses to the contractor agents 120 based on the performance metrics. For example, the administrator may assign a contractor agent 120 with high performance metrics the status of “preferred” and may assign a contractor agent 120 with low performance metrics the status of “not-preferred” or “do not use.”

The contractor engine 225 may consider statuses of contractor agents 120 when selecting contractor agents 120 to handle residuals 207. For example, when selecting contractor agents 120 to handle a residual 207 for a queue 125 for an interval, the contractor engine 225 may first offer the job to contractor agents 120 with preferred statuses. Only after the job is rejected by these agents 120 may the contractor engine 225 offer the job to contractor agents 120 with no status or the status of “not-preferred.” Under no circumstances may a job be offered to contractor agents 120 having a status of “do not use”.

After the contractor engine 225 places a contractor agent 120 on a queue 125 for an interval in response to a residual 207, the residual engine 205 may recalculate the residual 207 for the queue 125 and the interval. Depending on the embodiment, the residual engine 205 may recalculate all of the residuals 207, or just the residual 207 of the queue 125 for the associated interval. In addition, the residual engine 205 may recalculate residuals 207 after each contractor agent 120 placement, or after some number of contractor agents 120 have been placed. The number of placements that trigger a re-calculation may be set by a user or administrator, for example.

The contractor engine 225 may further recommend that one or more permanent or non-contractor agents 120 be hired. For example, if the contractor engine 225 determines residuals 207 that occur consistently for one or more queues 120 and intervals associated with the longer term planning horizon, there may be a need for one or more permanent agents 120 to be assigned to the one or more queues 120. In such cases, the contractor engine 225 may send a recommendation that the one or more agents 120 be hired to an administrator.

FIG. 3 is an illustration of an example method 300 for calculating a residual for a queue and for requesting agents based on the residual. The method 300 may be performed by the contractor service 170.

At 310, an indicator of a queue is received. The indicator may be received by the residual engine 205. In addition, an indicator of an interval of a plurality of intervals may be received along with a service level goal for the queue 125 during the interval.

At 315, a number of agents scheduled to work the queue is determined. The number of agents 125 may be determined by the residual engine 205 using a schedule 211 associated with the queue 125 or contact center 150.

At 320, a number of agents needed to meet the service level goal is determined. The number of agents needed to meet the service level goal may be determined by the residual engine 205. In some embodiments, the number of agents 120 may be determined using a forecast 209 that predicts the number of communications that the queue 125 may receive for the interval. In other embodiment, the number of agents 120 may be determined by simulating the operation of the queue 125 and the contact center 150 for the interval over several iterations. The residual engine 205 may then determine the number of agents 120 needed to meet the service goals using a binary search.

At 325, a residual is calculated for the queue. The residual 207 may be calculated for the queue 125 by the residual engine 205 as a difference between the number of agents 120 scheduled to work on the queue 125 for the interval and the number of agents 120 needed to meet the service level goal for the queue 125 for the interval.

At 330, additional agents are requested based on the residual. The additional agents 120 may be contractor agents 120 and may be requested by the contractor engine 225. The contractor engine 225 may request contractor agents 120 that have the skill associated with the queue 125 and that are not scheduled to work on another queue 125 associated with the contact center 150.

FIG. 4 is an illustration of an example method 400 for requesting agents for a plurality of queues based on residuals calculated for each queue. The method 400 may be implemented by the contractor service 170.

At 410, indicators of a plurality of queues are received. The indicators may be received by the residual engine 205. The plurality of queues 125 may be associated with a contact center 150 or other entity. Each queue 125 may be associated with a quality service goal for one or more intervals of a plurality of intervals.

At 415, a residual is calculated for each queue and for each interval. The residuals 207 for each queue 125 and interval may be calculated by the residual engine 205. Depending on the embodiment, how the residual engine 205 calculates the residual 207 for a queue 125 may depend on what horizon the interval is associated with and whether or not the queue 125 is an immediate or a deferred queue 125.

At 420, additional agents are requested for each queue and each interval based on the calculated residuals. The additional agents 120 may be contractor agents 120 and may be requested by the contractor engine 225. Depending on the embodiment, as the requested contractor agents 120 are assigned to the queues 125 for some or all of the intervals, the residual engine 205 may recalculate the residuals 207 for the plurality of queues 125 and intervals.

FIG. 5 is an illustration of an example method 500 for determining residuals for a plurality of queues. The method 500 may be implemented by the contractor service 170.

At 510, indicators of a plurality of queues are received. The indicators may be received by the residual engine 205. The plurality of queues 125 may be associated with a contact center 150 or other entity. Each queue 125 may be associated with a quality service level goal for one or more intervals of a plurality of intervals.

At 515, a schedule and a forecast are received for each queue. The schedule 211 and forecast 209 may be received by the residual engine 205. The schedule 211 and forecast 209 may be associated with a particular interval of the plurality of intervals.

At 520, the plurality of queues is simulated using the received schedule and forecast. The plurality of queues 125 may be simulated for the interval based on the schedule 211 and the forecast 209. Any method for simulating one or more queues 125 of a contact center 150 may be used.

At 525, understaffed queues are determined based on the simulations. The understaffed queues 125 may be determined by the residual engine 205 by performing one or more binary searches on the results of the simulations. Other methods may be used.

At 530, residuals are determined based on the understaffed queues. The residuals 207 may be determined by the residual engine 205. Depending on the embodiment, the residual 207 for an interval may be proportional to the number of agents 120 that each queue 125 is understaffed by.

FIG. 6 is an illustration of an example method 600 for determining residuals for a plurality of queues. The method 600 may be implemented by the contractor service 170.

At 605, one or more queues are simulated for a plurality of intervals. The one or more queues 125 may be simulated by the residual engine 205 using a schedule 211 and a forecast 209 associated with the one or more queues 125. Depending on the embodiment, the method 600 may be run response to an action such as a schedule 211 run, a forecast 209 run, and a prediction of a surge.

At 610, a determination is made as to whether any of the one or more queues 120 will meet their associated goals for one or more intervals. The determination may be made by the residual engine 205 using the results of the simulation. The goals may be service level goals, for example. If it is determined that the one or more queues 120 will meet their goals, the method 600 may continue at 615. Else, the method 600 may continue at 620.

At 615, that no residual is needed is determined. After making the determination, the method 600 may exit.

At 615, the residual is determined. The residual 207 may be determined by the residual engine 205. If the intervals are associated with the interweek/interday or the scheduling horizon, the residual 207 may be determined using the residual need algorithm. If the one or more intervals are part of the long term scheduling horizon, the residual 207 may be determined using the planning residual need algorithm. Other methods for calculating residuals 207 may be used.

At 625, the residual is output. The residual 207 may be output by the contractor engine 225. For example, the contactor engine 225 may provide the determined residual 207 to one or more contractor agents 120.

FIG. 7 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers, servers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 7, an exemplary system for implementing aspects described herein includes a computing device, such as computing device 700. In its most basic configuration, computing device 700 typically includes at least one processing unit 702 and memory 704. Depending on the exact configuration and type of computing device, memory 704 may be volatile (such as random access memory (RAM)), non-volatile (such as read-only memory (ROM), flash memory, etc.), or some combination of the two. This most basic configuration is illustrated in FIG. 7 by dashed line 706.

Computing device 700 may have additional features/functionality. For example, computing device 700 may include additional storage (removable and/or non-removable) including, but not limited to, magnetic or optical disks or tape. Such additional storage is illustrated in FIG. 7 by removable storage 708 and non-removable storage 710.

Computing device 700 typically includes a variety of tangible computer readable media. Computer readable media can be any available tangible media that can be accessed by device 700 and includes both volatile and non-volatile media, removable and non-removable media.

Tangible computer storage media include volatile and non-volatile, and removable and non-removable media implemented in any method or technology for storage of information such as computer readable instructions, data structures, program modules or other data. Memory 704, removable storage 708, and non-removable storage 710 are all examples of computer storage media. Tangible computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of computing device 700.

Computing device 700 may contain communications connection(s) 712 that allow the device to communicate with other devices. Computing device 700 may also have input device(s) 714 such as a keyboard, mouse, pen, voice input device, touch input device, etc. Output device(s) 716 such as a display, speakers, printer, etc. may also be included. All these devices are well known in the art and need not be discussed at length here.

Returning to FIG. 1, agent(s) 120 and customers 110 may communicate with each other and with other services over the network 130. For example, a customer calling on telephone handset may connect through the PSTN and terminate on a private branch exchange (PBX). A video call originating from a tablet may connect through the network 130 terminate on the media server. A smartphone may connect via the WAN and terminate on an interactive voice response (IVR)/intelligent virtual agent (IVA) components. IVR are self-service voice tools that automate the handling of incoming and outgoing calls. Advanced IVRs use speech recognition technology to enable customers to interact with them by speaking instead of pushing buttons on their phones. IVR applications may be used to collect data, schedule callbacks and transfer calls to live agents. IVA systems are more advanced and utilize artificial intelligence (Al), machine learning (ML), advanced speech technologies (e.g., natural language understanding (NLU)/natural language processing (NLP)/natural language generation (NLG)) to simulate live and unstructured cognitive conversations for voice, text and digital interactions. In yet another example, Social media, email, SMS/MMS, IM may communicate with their counterpart's application (not shown) within the contact center 150.

The contact center 150 itself be in a single location or may be cloud-based and distributed over a plurality of locations. The contact center 150 may include servers, databases, and other components. In particular, the contact center 150 may include, but is not limited to, a routing server, a SIP server, an outbound server, a reporting/dashboard server, automated call distribution (ACD), a computer telephony integration server (CTI), an email server, an IM server, a social server, a SMS server, and one or more databases for routing, historical information and campaigns.

The ACD is used by inbound, outbound and blended contact centers to manage the flow of interactions by routing and queuing them to the most appropriate agent. Within the CTI, software connects the ACD to a servicing application (e.g., customer service, CRM, sales, collections, etc.), and looks up or records information about the caller. CTI may display a customer's account information on the agent desktop when an interaction is delivered. Campaign management may be performed by an application to design, schedule, execute and manage outbound campaigns. Campaign management systems are also used to analyze campaign effectiveness.

For inbound SIP messages, the routing server may use statistical data from reporting/dashboard information and a routing database to the route SIP request message. A response may be sent to the media server directing it to route the interaction to a target agent 120. The routing database may include: customer relationship management (CRM) data; data pertaining to one or more social networks (including, but not limited to network graphs capturing social relationships within relevant social networks, or media updates made by members of relevant social networks); agent skills data; data extracted from third party data sources including cloud-based data sources such as CRM; or any other data that may be useful in making routing decisions.

The integration of real-time and non-real-time communication services may be performed by unified communications (UC)/presence sever. Real-time communication services include Internet Protocol (IP) telephony, call control, instant messaging (IM)/chat, presence information, real-time video and data sharing. Non-real-time applications include voicemail, email, SMS and fax services. The communications services are delivered over a variety of communications devices, including IP phones, personal computers (PCs), smartphones and tablets. Presence provides real-time status information about the availability of each person in the network, as well as their preferred method of communication (e.g., phone, email, chat and video).

Recording applications may be used to capture and play back audio and screen interactions between customers and agents. Recording systems should capture everything that happens during interactions and what agents do on their desktops. Surveying tools may provide the ability to create and deploy post-interaction customer feedback surveys in voice and digital channels. Typically, the IVR/IVA development environment is leveraged for survey development and deployment rules. Reporting/dashboards are tools used to track and manage the performance of agents, teams, departments, systems and processes within the contact center. Reports are presented in narrative, graphical or tabular formats. Reports can be created on a historical or real-time basis, depending on the data collected by the contact center applications. Dashboards typically include widgets, gadgets, gauges, meters, switches, charts and graphs that allow role-based monitoring of agent, queue and contact center performance. Unified messaging (UM) applications include various messaging and communications media (voicemail, email, SMS, fax, video, etc.) stored in a common repository and accessed by users via multiple devices through a single unified interface.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving indicators of a plurality of queues;
for each queue of the plurality of queues:
for each interval of a plurality of intervals:
determining a number of agents scheduled to work on the queue for the interval;
determining a number of agents needed to meet a service level goal for the interval;
calculating a residual for the interval based on a difference between the determined number of agents scheduled and the determined number of agents needed; and
requesting additional agents for the queue based on the residual.

2. The method of claim 1, wherein determining the number of agents needed to meet the service level goal comprises receiving a forecast for the interval and an average handling time for the queue and determining the number of agents needed based on the forecast and the average handling time.

3. The method of claim 1, wherein determining a number of agents needed to meet a service level goal for the interval comprises simulating the queue for the interval.

4. The method of claim 1, wherein determining a number of agents needed to meet a service level goal for the interval comprises performing a binary search.

5. The method of claim 1, wherein the intervals are associated with one of an intraday or intraweek horizon, a scheduling horizon, or a longer term planning horizon.

6. The method of claim 1, wherein the method is performed in response to detecting a surge.

7. The method of claim 1, wherein the method is performed in response to determining a change to the number of agents scheduled to work on a queue.

8. The method of claim 1, further comprising:
in response to the request for additional agents, notifying at least one agent about an available interval for a queue of the plurality of queues;
in response to the notification, receiving a request from the at least one agent to work during the available interval; and
scheduling the at least one agent to work during the available interval.

9. The method of claim 1, wherein the at least one agent comprises one or more of a freelance agent, an outsourced agent, a new agent, or a currently employed agent.

10. The method of claim 1, further comprising:
in response to the request for additional agents, notifying at least one outsourced agent about a plurality of available intervals for a queue of the plurality of queues;
in response to the notification, receiving a request from the at least one outsourced agent to work during the plurality of intervals; and
scheduling the at least one agent to work during the plurality of intervals.

11. The method of claim 1, requesting additional agents for the queue based on the residual comprises requesting that additional full or part time agents be hired based on the residual.

12. A system comprising:
at least one processor; and
a non-transitory computer readable medium comprising instructions that, when executed by the at least one processor, cause the system to:
receive indicators of a plurality of queues;
for each queue of the plurality of queues:
for each interval of a plurality of intervals:
determine a number of agents scheduled to work on the queue for the interval;
determine a number of agents needed to meet a service level goal for the interval;
calculate a residual for the interval based on a difference between the determined number of agents scheduled and the determined number of agents needed; and
request additional agents for the queue based on the residual.

13. The system of claim 12, wherein determining the number of agents needed to meet the service level goal comprises receiving a forecast for the interval and an average handling time for the queue and determining the number of agents needed based on the forecast and the average handling time.

14. The system of claim 12, wherein determining a number of agents needed to meet a service level goal for the interval comprises simulating the queue for the interval.

15. The system of claim 12, wherein determining a number of agents needed to meet a service level goal for the interval comprises performing a binary search.

16. The system of claim 12, wherein the intervals are associated with one of an intraday or intraweek horizon, a scheduling horizon, or a longer term planning horizon.

17. The system of claim 12, further comprising instructions that, when executed by the at least one processor, cause the system to:
in response to the request for additional agents, notify at least one agent about an available interval for a queue of the plurality of queues;
in response to the notification, receive a request from the at least one agent to work during the available interval; and
schedule the at least one agent to work during the available interval.

18. A non-transitory computer readable medium comprising instructions that, when executed by at least one processor, cause a computing system to:
receive indicators of a plurality of queues;
for each queue of the plurality of queues:
for each interval of a plurality of intervals:
determine a number of agents scheduled to work on the queue for the interval;
determine a number of agents needed to meet a service level goal for the interval;
calculate a residual for the interval based on a difference between the determined number of agents scheduled and the determined number of agents needed; and
request additional agents for the queue based on the residual.

19. The computer readable medium of claim 18, wherein determining the number of agents needed to meet the service level goal comprises receiving a forecast for the interval and an average handling time for the queue and determining the number of agents needed based on the forecast and the average handling time.

20. The computer readable medium of claim 18, wherein determining a number of agents needed to meet a service level goal for the interval comprises simulating the queue for the interval.
